(19) United States
(12) Patent Application Publication
(10) Pub. No.: US 2017/0122334 A1
(43) Pub. Date: May 4, 2017

(54) Illuminated Ceiling Fan Blades

(71) Applicant: Mel Cox, Lighthouse Point, FL (US)

(72) Inventor: Mel Cox, Lighthouse Point, FL (US)

(21) Appl. No.: 14/927,829

(22) Filed: Oct. 30, 2015

(51) Int. Cl. F04D 29/32; F21V 33/00; F04D 25/08; F21K 2/00

(52) U.S. Cl. CPC F04D 29/325; F21K 2/00; F21V 33/0096; F04D 25/088

(57) ABSTRACT

A photo luminescent acrylic fan blade that can be formed with roughened edges to emit increased amounts of light to the light emitting edges of the fan blade. The fan blades have one or more roughened edges that are formed on a single blade. An optional alternative embodiment provides a fan blade formed such that light emitting surfaces or patterns are located on the fan blade surface and away from the edges of the fan blade.

### BACKGROUND

Technical Field

This invention relates in general to fan blades, and more particularly it relates to illuminated fan blades with edge illumination and/or illumination of surface aesthetic design patterns.

Background of the Invention

Ceiling fans are highly popular devices that provide a significant amount of comfort for individuals. In addition, because of their usefulness in terms of reducing the apparent temperature in hot climates, they are also very useful in reducing energy usage and cost. While the practical advantages of ceiling fans are well known, there as well also been substantial efforts to improve the aesthetics of ceiling fans. In particular, a great variety of ornamental work has been done on both the motor drive covers, as well as the fan blades themselves. In regard to the fan blades, there are a substantial variety of fan blade styles available to suit any particular decor or match any furniture style.

One attempt to improve the variety of fan blades provides a UV poly acrylic or light reactive plastic in which the edge of the blade illuminates when exposed to black UV light. While this invention is useful for its intended purposes, it has several drawbacks. One disadvantage is that it requires a black light to illuminate the fan blades. This requires extra components that increase manufacturing costs and may limit aesthetic design choices. Following manufacture, it requires ongoing costs for supplying power to activate the black light. It would be desirable to have a method of illuminating fan blades without the need for active light sources, and to provide an illumination system that does not require power.

Finally, UV poly acrylic or black light reactive plastic does not provide for aesthetic patterns or images on the fan blade, as just the edge of the blade illuminates. It would be desirable to have a fan blade in which predetermined portions of the blade, other than the edges, would illuminate to display a desired pattern, or to distribute light to specific areas of the fan blade.

While the prior art has provided a variety of ornamental fan blades, it has failed to provide a fan blade that illuminates solely through the use of ambient light, and illuminates predetermined images, or distributes light to specific areas of the fan blade.

### SUMMARY OF THE INVENTION

This invention provides photo luminescent acrylic fan blades that can be formed to direct light to the light emitting edges of the fan blade. The fan blades can have single or multiple edges that are formed on a single blade. An optional alternative embodiment provides a fan blade formed such that light emitting surfaces are located on the fan blade away from the edges.

### BRIEF DESCRIPTION OF THE DRAWINGS

FIG. 1 is a top view of a preferred embodiment of the invention in which a single illumination edge is illustrated.

FIG. 2 is a side edge view of a preferred embodiment of the invention in which a single illumination edge is illustrated.

FIG. 3A is a side view of a preferred embodiment of the invention in which the edge of the blade is formed with curved multiple light emitting portions.

FIG. 3B is a side view of a preferred embodiment of the invention in which the edge of the blade is formed with flat multiple light emitting portions.

FIG. 4 is top view of a preferred embodiment of the invention in which an ornamental surface design is illustrated.

FIG. 5 is a top view of a preferred embodiment of the invention in which the light emitted varies based to the amount of ornamental surface design.

### DETAILED DESCRIPTION OF THE PREFERRED EMBODIMENT

Prior to a discussion of the figures, an overview of the invention will be presented. The invention is an improved fan blade that uses Plexiglas Acrylic Fluorescent Plastic. For ease of discussion, Plexiglas Acrylic Fluorescent Plastic will be referred to herein as photo luminescent acrylic. Photo luminescent acrylic absorbs black, fluorescent, or ambient UV light and reemits visible over an extended time period. One commercially available photo luminescent acrylic is available from Acrilex, Inc., who produces the acrylic under the trade name Acriglo™. Acriglo is a magnesium strontium silicate photo luminescent acrylic. It has a useful property in that it absorbs energy from ambient light and slowly reemits it over an extended period of time. This property has found useful application in lighting systems. For example, panels made from this material are used in conjunction with ceiling fluorescent lighting panels. When there is a power outage, the panels will reemit the light absorbed from the fluorescent lamps over an extended period of time. As a result, light is available for what would otherwise be a dark hallway or other enclosed area. This provides a safety feature that does not require any power, such as that used by conventional emergency lighting systems.

The photo luminescent acrylic is available in a variety of colors, including orange/red, yellow, blue, green, and orange. It has been found that orange/red and green provide the brightest glow.

We have discovered that when the edges of the acrylic are machined, sanded, cut or molded to produce a roughened surface, the roughened surfaces emit an increased amount of light. As a result, this difference in the amount of emitted light allows a variety of aesthetic effects to be achieved. When the photo luminescent acrylic fan blade is machined at the edges, it produces a visible outline of the fan blade. In addition, other aesthetic effects can be achieved. For example, if the edge of the fan blade is formed such that the blade has two edges, offset from one another, the concentric lines of light will be displayed around the edge of the blade. Likewise, when design patterns are machined into the surface of the fan blade, they also are more brightly illuminated then the flat surfaces of the fan blade. As a result, any number of ornamental images can be engraved on the surface of the photo luminescent fan blade to produce an aesthetic image for a particular design goal.

The fan blades can be fabricated using injection molding or other suitable molding techniques. Likewise, they can be machined from flat panels. The fabrication process should also include an edge-roughening step, if needed, to ensure that the fan blades illuminate in the desired areas. The roughening can be accomplished via abrasives (sandpaper, etc.) of via the molding process. The fabrication process can produce any desired shape for the fan blade to suit a particular aesthetic design goal.

Another effect that can be achieved by the invention is to vary the light emitted by various sections of the photo luminescent fan blade. For example, if the surface is more machined on different sections of the photo luminescent fan blade, then more light will be emitted from those sections. This will allow a variety of aesthetic design goals to be achieved. For example, if properly done the fan blade can be designed to emit more light at the outer tip of the blade then the portion of the fan blade closest to the motor, or vice versa.

An alternative embodiment of the invention is a retrofit kit that provides photo luminescent fan blades that can replace conventional fan blades or photo luminescent fan blades 1 having a different color. The retrofit kit allows a fan to be inexpensively upgraded. In addition, this embodiment allows fan blades to be interchanged for a variety of effects, such as changing the color of the fan blade when switching from one sports season to another, or for holidays such as Christmas, Thanksgiving, etc.

Those skilled in the art will recognize that the photo luminescent fan blades 1 can be manufactured with a variety of colors. As a result, colors associated with holidays, schools, or sports teams can be used. When used with the retrofit kit, the fan blades can be exchanged when the season for a given sport ends and the season for a different sport begins. For example, team colors of the local baseball team may be used during the summer, and exchanged for the team colors of the local football team during the fall.

Having discussed the invention in general, we turn now to a detailed discussion of the figures.

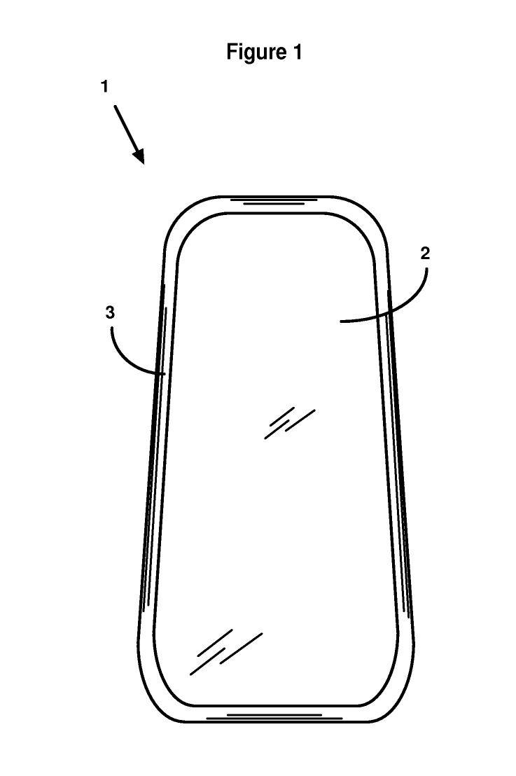

FIG. 1 is a top view of a preferred embodiment of the invention in which a photo luminescent fan blade 1 with single illumination edge 3 is illustrated. Illumination edge 3 is roughened, and as a result, illumination edge 3 projects a brighter light than the rest of photo luminescent fan blade 1. The roughening can be accomplished in a number of ways. For example, it can be done mechanically via sanding, chemically, or by using a mold that creates a roughened surface. By roughening the edge of photo luminescent fan blade 1, a bright light will extend around the edge of the fan blade. This top view shows the surface 2 of the fan blade that would face downward during normal use.

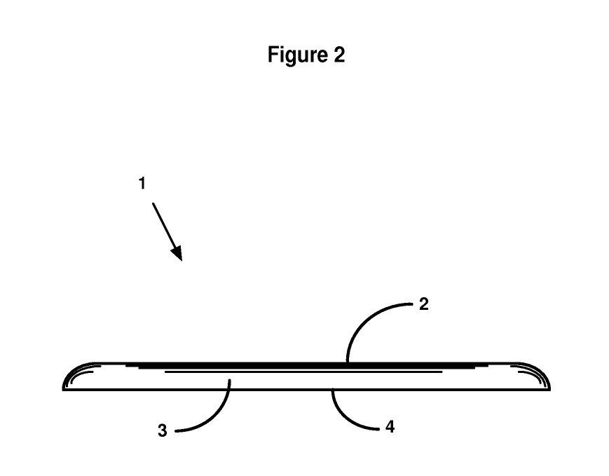

FIG. 2 is a side view of a preferred embodiment of the invention in which a single peripheral illumination edge 3 for a fan blade 1 is illustrated. As can be seen from this figure, the peripheral illumination edge 3 is carved in a simple curve. Those skilled in the art will recognize that a variety of shapes can be used when the photo luminescent fan blade 1 is machined. Depending on the shape used to machine a portion of the surface of the fan blade 1 the amount of light emitted can be greater or lesser. Also shown in this figure is the bottom surface 4 of the fan blade 1. During normal use, bottom surface 4 would be positioned facing the ceiling.

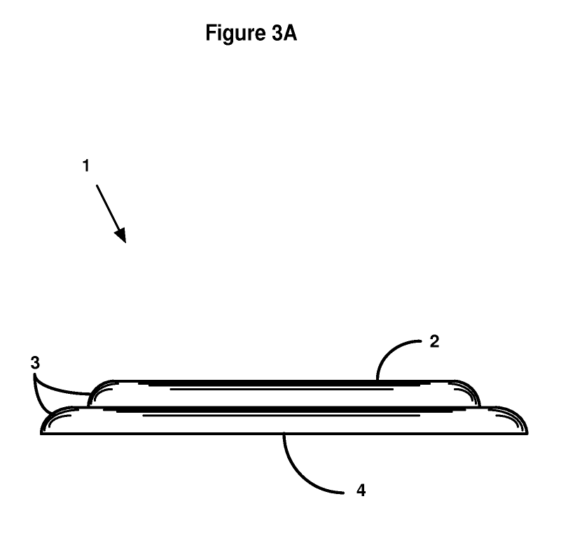

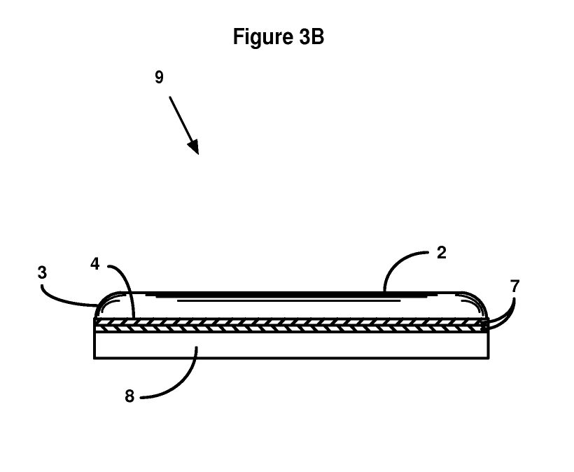

FIG. 3A is a side view of a preferred embodiment of the invention in which multiple curved illumination edges 3 are illustrated. In this illustration, the photo luminescent fan blade 1 is a single blade in which the peripheral edge is formed having two or more roughened portions on its peripheral edge, each portion acting as an illumination edge 3. The machined portions are offset from one another to produce concentric illuminated edges.

FIG. 3B is a side view of an alternative preferred embodiment of the invention shown in FIG. 3A in which multiple optional flat illumination edges 7 are illustrated.

In addition to the foregoing, the photo luminescent fan blade 1 can be comprised of two separate fan blades that are adhered to one another. This would allow each layer of the fan blade 1 to be fabricated from material having a different color. Of course, those skilled in the art will recognize that care must be taken to ensure that the individual color layers are thin enough such that their combined weight will not interfere with proper operation of the fan. This embodiment allows photo luminescent fan blades 1 to be fabricated that have special combinations of colors, such as those used by sports teams, colleges, etc. Likewise, for holidays such as Christmas, the proximal portion of one layer may be machined to display a green color while the distal portion of the other layer may be machined to display a red color.

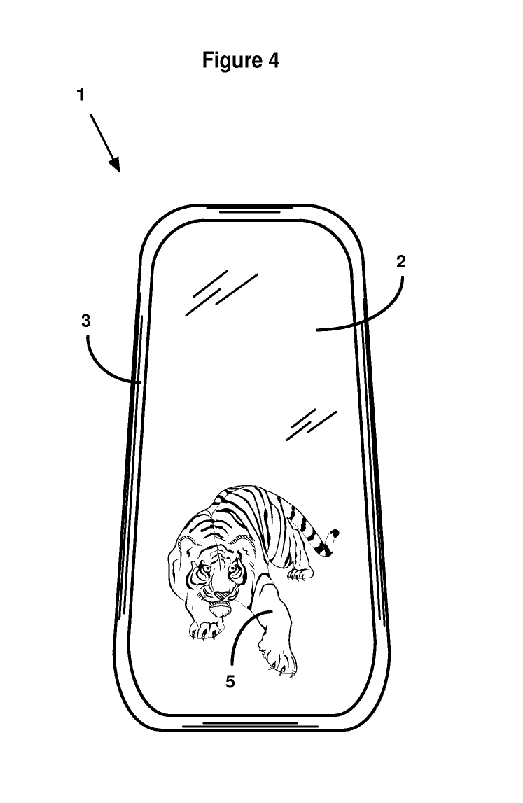

FIG. 4 is top view of a preferred embodiment of the invention in which an ornamental surface design 5 is illustrated. In this figure, the image is far from the edge of the fan blade and will cause the image to glow brightly in comparison to the flat surface of the remainder of the fan blade 1. To accomplish this, the image is engraved into the surface of the fan blade, or alternatively, molded into the surface of the fan blade. As was the case in regard to the edges of the fan blade 1, the image must be roughened to produce the desired brightness.

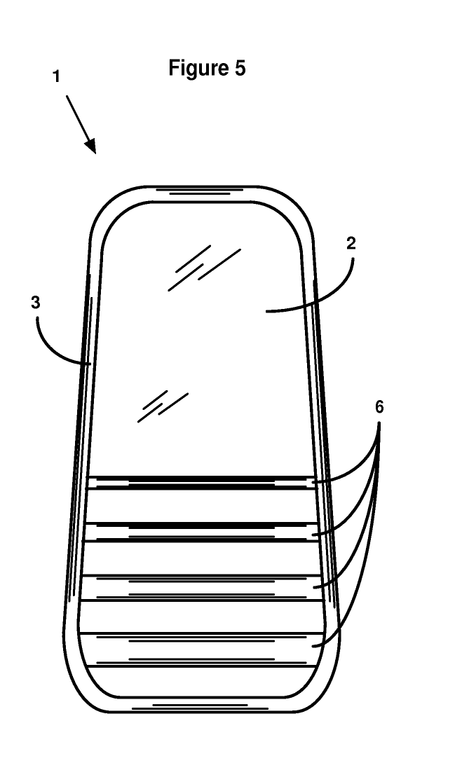

FIG. 5 is a top view of a preferred embodiment of the invention in which the light emitted varies based to the amount of ornamental surface design. In addition to the machined peripheral edge 3 of the fan blade 1, there is a sequence of additional machined carvings 6 which extend from the distal edge of the fan blade 1 toward the proximal edge of the fan blade 1. When the fan when 1 is moving, there will be a greater amount of light emitted from the distal end of the fan blade 1 as opposed to the proximal end of the fan blade 1. Depending on the arrangement of the additional machined carvings 6, a variety of interesting lighting effects can be achieved.

While specific embodiments have been discussed to illustrate the invention, it will be understood by those skilled in the art that variations in the embodiments can be made without departing from the spirit of the invention. For example, while photo luminescent acrylic has been used to illustrate the principles of the invention, any suitable photo luminescent material can be used. The thickness of the photo luminescent fan blade 1 can vary, the shape of the surfaces which are machined can vary, etc. Therefore, the invention shall be limited solely by the scope of the claims.

I claim:

1. A photo luminescent fan blade, comprising:
a photo luminescent fan blade fabricated from material that absorbs ambient light and re-emits it when the fan blade is in a dark area;
an upper surface and a lower surface;
a peripheral edge having a distal edge, a proximal edge, and two opposing side edges;
at least a portion of the fan blade roughened such that when light is re-emitted, more light is re-emitted from the roughened surfaces than the non-roughened surfaces of the photo luminescent fan blade.

2. A photo luminescent fan blade, as in claim 1, wherein:
at least a portion of the roughened peripheral edge is curved to provide increased light emission.

3. A photo luminescent fan blade, as in claim 1, wherein:
the upper or lower surface has an ornamental design machined into it, the ornamental design having roughened surfaces that emit more light than the surrounding non-roughened surface.

4. A photo luminescent fan blade, as in claim 1, wherein:
the upper or lower surface is roughened in preselected areas such that when the fan is operating, more light is re-emitted from the roughened area of the upper or lower surface than from the non-roughened areas.

5. A photo luminescent fan blade, as in claim 1, wherein:
at least two roughened edges are positioned on the fan blade such that one roughened edge is offset from the other roughened edge.

6. A photo luminescent fan blade, as in claim 1, wherein:
the photo luminescent fan blade is fabricated from photo luminescent acrylic.

7. A photo luminescent fan blade, as in claim 6, wherein:
at least a portion of the peripheral edge is roughened to provide increased light emission.

8. A photo luminescent fan blade, as in claim 6, wherein:
the upper or lower surface has a roughened surface area which forms an ornamental design.

9. A photo luminescent fan blade, as in claim 6, wherein:
the upper or lower surface has more roughened surfaces in preselected areas such that when the fan is operating, more light is re-emitted from the preselected areas than from other areas.

10. A photo luminescent fan blade, as in claim 6, wherein:
at least two layers of photo luminescent material are used to fabricate the fan blade, each layer having a preselected color.

11. A retrofit kit for a photo luminescent fan blade, as in claim 6, further comprising: or
a plurality of photo luminescent fan blade sets sized to replace a conventional fan blade set, each photo luminescent fan blade set having a preselected color, shape, or aesthetic design.

12. A photo luminescent fan blade, as in claim 7, further comprising:
the acrylic used to fabricate the photo luminescent fan blade is magnesium strontium silicate photo luminescent acrylic.

13. A photo luminescent fan blade, as in claim 12, wherein:
at least a portion of the peripheral edge is roughened to provide increased light emission.

14. A photo luminescent fan blade, as in claim 12, wherein:
the upper or lower surface has one or more roughened areas that form an ornamental design.

15. A photo luminescent fan blade, as in claim 12, wherein:
the upper or lower surface has more roughened surfaces in preselected areas such that when the fan is operating, more light is re-emitted from the preselected areas than from other areas.

16. A photo luminescent fan blade, as in claim 12, wherein:
at least two layers of photo luminescent material are used to fabricate the fan blade, each layer having a preselected color.

17. A retrofit kit for a photo luminescent fan blade, as in claim 12, further comprising:
a plurality of photo luminescent fan blade sets sized to replace a conventional fan blade set, each photo luminescent fan blade set having a preselected color, shape, or aesthetic design.
